(19) United States
(12) Patent Application Publication
(10) Pub. No.: US 2025/0142547 A1
(43) Pub. Date: May 1, 2025

(54) METHOD FOR WIRELESS COMMUNICATION AND DEVICE

(71) Applicant: GUANGDONG OPPO MOBILE TELECOMMUNICATIONS CORP., LTD., Dongguan (CN)

(72) Inventors: Jing XU, Dongguan (CN); Yanan LIN, Dongguan (CN); Bin LIANG, Dongguan (CN); Yi ZHANG, Dongguan (CN)

(21) Appl. No.: 19/006,132

(22) Filed: Dec. 30, 2024

Related U.S. Application Data
(63) Continuation of application No. PCT/CN2022/104738, filed on Jul. 8, 2022.

(51) Int. Cl. H04W 72/0457; H04L 5/00; H04W 72/0453

(52) U.S. Cl. CPC H04W 72/0457; H04L 5/0048; H04W 72/0453

(57) ABSTRACT

Provided is a method for wireless communication. The method is applicable to a first node, and includes: transmitting a set of signals, the set of signals including at least one first signal and at least one second signal, wherein the at least one first signal is transmitted based on configuration information, and the at least one second signal is transmitted upon modulation based on channel information of a first channel.

### CROSS-REFERENCE TO RELATED APPLICATION

This application is a continuation application of International Application No. PCT/CN2022/104738, filed on Jul. 8, 2022, the entire disclosure of which is incorporated herein by reference.

### TECHNICAL FIELD

Embodiments of the present disclosure relates to the technical field of communications, and in particular, relate to a method and apparatus for wireless communication, and a device and a storage medium thereof.

### BACKGROUND

In wireless communication scenarios in some practices, in the case that accurate channel information needs to be acquired, channel information is first quantized and then fed back by transmitting signaling carrying the quantitated channel information.

### SUMMARY

Embodiments of the present disclosure provide a method for wireless communication and a device thereof. The technical solutions are as follows.

According to some embodiments of the present disclosure, a method for wireless communication is provided. The method is applicable to a first node, and includes:
transmitting a set of signals, the set of signals including at least one first signal and at least one second signal, wherein the at least one first signal is transmitted based on configuration information, and
the at least one second signal is transmitted upon modulation based on channel information of a first channel.

According to some embodiments of the present disclosure, a method for wireless communication is provided. The method is applicable to a second node, and includes:
receiving a set of signals from a first node, the set of signals including at least one first signal and at least one second signal, wherein the at least one first signal is transmitted by the first node based on configuration information, and
the at least one second signal is transmitted upon modulation based on channel information of a first channel.

According to some embodiments of the present disclosure, a communication device is provided. The communication device includes: a processor, a transceiver connected to the processor, and a memory storing one or more executable programs of the processor; wherein the processor, when loading and running the one or more executable programs, is caused to perform the method for wireless communication in the above embodiments.

According to some embodiments of the present disclosure, a communication device is provided. The communication device includes: a processor, a transceiver connected to the processor, and a memory storing one or more executable programs of the processor; wherein the processor, when loading and running the one or more executable programs, is caused to perform the method for wireless communication in the above embodiments.

### BRIEF DESCRIPTION OF DRAWINGS

For clearer descriptions of the technical solutions according to the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a schematic scenario diagram of a sensing mode according to some embodiments of the present disclosure;

FIG. 2 is a schematic diagram of a wireless communication scenario according to some embodiments of the present disclosure;

FIG. 3 is a schematic diagram of a wireless communication scenario according to some embodiments of the present disclosure;

FIG. 4 is a schematic diagram of a wireless communication scenario according to some embodiments of the present disclosure;

FIG. 5 is a schematic diagram of a wireless communication scenario according to some embodiments of the present disclosure;

FIG. 6 is a schematic flowchart of a method for wireless communication according to some embodiments of the present disclosure;

FIG. 7 is a schematic flowchart of a method for wireless communication according to some embodiments of the present disclosure;

FIG. 8 is a schematic flowchart of a method for wireless communication according to some embodiments of the present disclosure;

FIG. 9 is a schematic flowchart of a method for wireless communication according to some embodiments of the present disclosure;

FIG. 10 is a schematic flowchart of a method for wireless communication according to some embodiments of the present disclosure;

FIG. 11 is a schematic diagram of a wireless communication scenario according to some embodiments of the present disclosure;

FIG. 12 is a block diagram of an apparatus for wireless communication according to some embodiments of the present disclosure;

FIG. 13 is a block diagram of an apparatus for wireless communication according to some embodiments of the present disclosure; and

FIG. 14 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are described in detail hereinafter in conjunction with the accompanying drawings. Embodiments are illustratively described herein and are illustrated in the accompanying drawings. Unless otherwise indicated, the same number in different accompanying drawings indicates the same or similar elements in following descriptions of the accompanying drawings. The following exemplary embodiments do not represent all embodiments consistent with the present disclosure, and are merely examples of devices and methods that are consistent with aspects of the present disclosure as detailed in the appended claims.

The term “a plurality of” herein means two or more. The term “and/or” herein describes associations between contextual objects, and indicates three types of relationships. For example, the phrase “A and/or B” means (A), (B), or (A and B). The symbol “/” generally indicates an “or” relationship between the associated objects.

The terms used in the present disclosure are for describing specific embodiments and are not intended to limit the present disclosure. The terms “a,” “an,” and “the” in the singular form used in the present disclosure and the appended claims are also intended to include the plural form, unless clearly indicates in the context otherwise.

It should be understood that although the terms first, second, third, and the like may be used to describe various types of information in the present disclosure, such information should not be limited to the terms. The terms are used only to distinguish the same type of information. For example, without departing from the scope of the present disclosure, the first information may also be referred to as the second information, and likewise, the second information may also be referred to as the first information. Depending on the context, the term “if” used herein may be interpreted as the term “when,” “in the case that,” or “in response to.”

Next-generation networks, such as the 6^{th} Generation (6G) mobile communication network, are expected to be a fusion of a mobile communication network, a sensing network, and a computing network. In a narrow sense, the sensing network refers to a system with capabilities of target positioning (ranging, velocity measurement, angle measurement), target imaging, target detection, target tracking, and target recognition. In a broad sense, the sensing network refers to a system having attributes and states of all services, networks, users, terminals, and environmental objects.

Based on sensing applications, sensing includes following types: outdoor/wide area/local area applications, including smart city (such as weather monitoring and the like), smart transportation/high-speed rail (such as high-precision map construction, road supervision, intrusion detection, and the like), low-altitude applications (such as drone monitoring and obstacle avoidance, flight intrusion detection, flight path management, and the like); and indoor/local applications, including smart home and health management (such as breath monitoring, intrusion detection, gesture/posture recognition, motion monitoring, moving trajectory tracking, and the like), smart factory (such as intrusion detection, material detection, item defect detection, and the like).

The above are only examples of classification of sensing applications, and the scope of applications of sensing is not limited to the above examples.

Wireless communication and sensing are two importance applications in the modern radio frequency technology. The sensing achieves environmental sensing, for example, target positioning, action recognition, and imaging by detecting parameters of a physical environment over radio waves. Traditional sensing and wireless communication are independent of each other, and this design causes waste of wireless spectrum and hardware resources. In the era of beyond 5th generation mobile communication system (B5G) and 6G mobile communication system, the communication spectrum is in millimeter wave, terahertz, and visible light communication, and the spectrum of future wireless communication is coincident with traditional sensing spectrum. The communication sensing technology integration technology combines the wireless communication and the sensing, achieves the sensing function using wireless resources of the wireless communication, achieves a wider range of sensing services using widely deployed cellular networks, implements joint sensing using stations and a plurality of terminals to achieve higher sensing precision, and reuses the hardware module for wireless communication to implement the sensing function, such that the cost is reduced. In summary, the communication sensing integration technology enables the future wireless communication systems to have the sensing ability, and provides a basis for the future development of smart transportation, smart cities, smart factories, drones and other services.

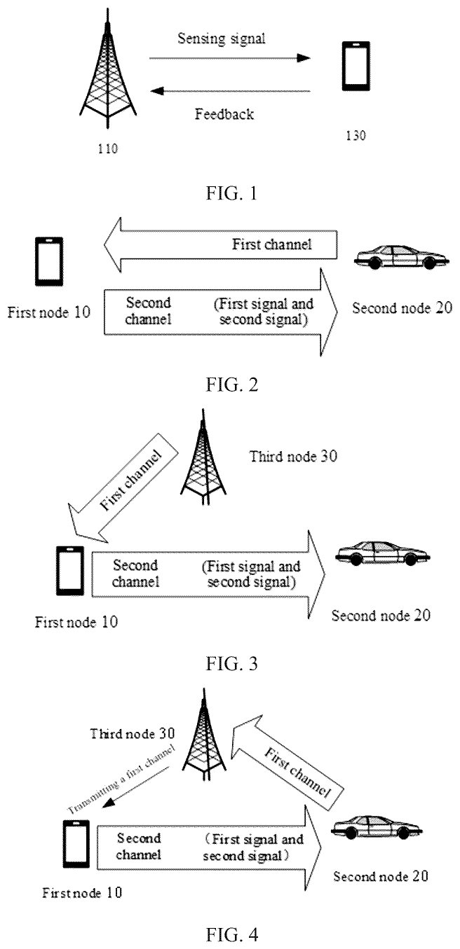

A sensing mode in some practices is shown in FIG. 1. A sensing transmitter (STx) 110 (such as a station) transmits a sensing signal to a sensing receiver (SRx) 130 (such as a terminal). The sensing signal instructs or requests the sensing receiver 130 to feed back sensing information. The sensing receiver 130 feeds back the sensing information to the sensing transmitter 110 in response to the received sensing signal. The sensing transmitter 110 is a sensing controller node or a sensing demand node. However, complete channel information needs to be fed back to extract much sensing environmental information, such as channel amplitude and phase of each subcarrier. In addition, quantization precision requirements are also stricter. In such a sensing mode, only lossy compressed channel information is fed back in the case that the quantization precision is lower, and information bits occupied by the quantized channel information are more in the case that the quantization precision is higher, and thus the feedback overhead of channel information is great.

Based on the above problems, feedback of the channel information is improved in the embodiments of the present disclosure, such that the resource overhead in feeding back the channel information is reduced on the premise of lossless feedback of the channel information. Some exemplary embodiments are described hereinafter. The technical solutions according to the embodiments of the present disclosure are applicable to various communication systems, such as a global system of mobile communication (GSM), a code-division multiple access (CDMA) system, a wideband code-division multiple access (WCDMA) system, a general packet radio service (GPRS) system, a long-term evolution (LTE) system, an LTE frequency-division duplex (FDD) system, an LTE time-division duplex (TDD) system, an advanced long-term evolution (LTE-A) system, a universal mobile telecommunication system (UMTS), a worldwide interoperability for microwave access (WiMAX) communication system, a 5G mobile communication system, a new radio (NR) system, an evolution system of the NR system, an LTE-based access to unlicensed spectrum (LTE-U) system, an NR-based access to unlicensed spectrum (NR-U) system, a non-terrestrial network (NTN) system, a wireless local area network (WLAN), a wireless fidelity (Wi-Fi), a cellular Internet of things (IoT) system, a cellular passive IoT system, evolution systems of the 5G NR system, and evolution systems of the 6G NR system. In some embodiments of the present disclosure, the “NR” is also referred to as a 5G NR system or a 5G system. The 5G mobile communication system includes a non-standalone (NSA) network and/or a standalone (SA) network.

The technical solutions according to the embodiments of the present disclosure are also applicable to machine-type communications (MTC), a long-term evolution-machine (LTE-M) technology, a device-to-device (D2D) network, a machine-to-machine (M2M) network, an IoT network, or other networks. The IoT network includes, for example, Internet of Vehicles. Communication modes in the Internet of Vehicles system are collectively referred to as vehicle-to-X (V2X, X represents anything). For example, the V2X includes (vehicle-to-vehicle (V2V) communications, vehicle-to-infrastructure (V2I) communications, vehicle-to-pedestrian (V2P) or vehicle-to-network (V2N) communications, and the like.

FIG. 2 to FIG. 5 illustratively show wireless communication scenarios in some embodiments of the present disclosure, and are not intended to limit application scenarios of the embodiments of the present disclosure.

As shown in FIG. 2, the wireless communication scenario includes a first node 10 and a second node 20. A channel from the second node 20 to the first node 10 is defined as a first channel, and a channel from the first node 10 to the second node 20 is defined as a second channel.

As shown in FIG. 3, the wireless communication scenario includes a first node 10, a second node 20, and a third node 30. A channel from the third node 30 to the first node 10 is defined as a first channel, and a channel from the first node 10 to the second node 20 is defined as a second channel.

As shown in FIG. 4, the wireless communication scenario includes a first node 10, a second node 20, and a third node 30. A channel from the second node 20 to the third node 30 is defined as a first channel, and a channel from the first node 10 to the second node 20 is defined as a second channel.

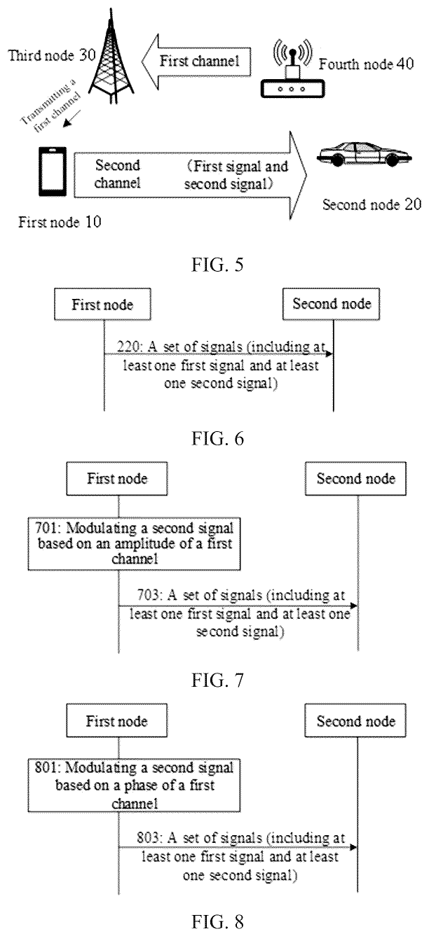

As shown in FIG. 5, the wireless communication scenario includes a first node 10, a second node 20, a third node 30, and a fourth node 40. A channel from the fourth node 40 to the third node 30 is defined as a first channel, and a channel from the first node 10 to the second node 20 is defined as a second channel.

In summary, the first channel is any channel over which the second node 20 expects to acquire the channel information, and the present disclosure does not limit the first channel, as long as the first node 10 can acquire or measure the channel information. In some embodiments of the present disclosure, the first channel and the channel information of the first channel are considered as the same concept.

In some embodiments, the first node or the second node is a network device. The network device includes, but is not limited to, an evolved node B (eNB), a radio network controller (RNC), a node B (NB), a base station controller (BSC), a base transceiver station (BTS), a home station (for example, home evolved node B or home node B (HNB)), a baseband unit (BBU), an access point (AP) in a Wi-Fi system, a wireless relay node, a wireless return node, a transmission point (TP), a transmission and reception point (TRP), a next generation node B (gNB), TRP or TP in a 5G system, one or a set of antenna panels (including a plurality of antenna panels) for a base station in a 5G system, or a network node that constitutes a gNB or a TP (such as a baseband unit (BBU) or a distributed unit (DU)), a base station in a 6G communication system, or the like.

In some embodiments, the first node or the second node is a terminal, or is referred to as a user equipment (UE), an access terminal, a subscriber unit, a subscriber station, a mobile station, a mobile console, a remote station, a remote terminal, a mobile device, a subscriber terminal, a terminal, a wireless communication device, a user agent, a user device, or the like. The terminal includes, but is not limited to, handheld devices, wearable devices, in-vehicle devices, IoT devices, and the like, such as a mobile phone, a tablet, an e-reader, a laptop, a desktop computer, a television, a game console, a mobile Internet device (MID), an augmented reality (AR) terminal, a virtual reality (VR) terminal, a mixed reality (MR) terminal, a wearable device, a hand shank, an electronic tag, a controller, a wireless terminal in the context of industry control, a wireless terminal in the context of self-driving, a wireless terminal in the context of remote medical, a wireless terminal in the context of smart gride, a wireless terminal in the context of transportation safety, a wireless terminal in the context of smart city, a wireless terminal in the context of smart home, a wireless terminal in the context of remove medical surgery, a cellular phone, a cordless phone, a session initiation protocol (SIP) phone, a wireless local loop (WLL) station, a personal digital assistant (PDA), a TV set-top box (STB), a customer premise equipment (CPE), and the like.

FIG. 6 is a schematic flowchart of a method for wireless communication according to some embodiments of the present disclosure. The method according to the embodiments is applicable to a first node, and includes at least part of following processes.

In S220, a set of signals is transmitted, wherein the set of signals includes at least one first signal and at least one second signal.

The set of signals is periodic, aperiodic, or semi-continuous.

In some embodiments, the set of signals is a set of reference signals, the first signal is a first reference signal, and the second signal is a second reference signal.

In some embodiments, the set of signals is a set of sensing signals, the first signal is a first sensing signal, and the second signal is a second sensing signal.

In some embodiments, a type of the first signal is the same or different from a type of the second signal, and the signal includes at least one of a channel state information-reference signal (CSI-RS), a demodulation reference signal (DMRS), a phase tracking-reference signal (PT-RS), a sounding reference signal (SRS), a synchronization signal block (SSB), or a sensing signal.

The first signal is transmitted by the first node based on configuration information, and the second signal is transmitted by the first node upon modulation based on a first channel. That is, the first signal is not modulated based on channel information of the first channel, and the second signal is modulated based on the channel information of the first channel. The first signal and the second signal are transmitted based on the configuration information. In the case that the configuration information includes configuration of the first signal and configuration of the second signal, the first signal is transmitted based on the configuration of the first signal, and the second signal is transmitted based on the configuration of the second signal. The second signal is additionally modulated based on the channel information of the first channel and transmitted.

The first node transmits a set of signals to the second node. In some embodiments, the first channel is a channel from the second node to the first node. Alternatively, the first channel is a channel from another node to the first node, for example, a channel from the third node to the first node. Alternatively, the first channel is a channel from the second node to another node, for example, a channel from the second node to the third node. Alternatively, the first channel is a channel from the fourth node to the third node.

The second channel is a channel from the first node to the second node. The first signal is transmitted over the second channel based on the configuration information without modulation based on the channel information of the first channel, and the second signal is transmitted over the second channel based on the configuration information upon modulation based on the channel information of the first channel. Thus, the first signal transmitted over the second channel carries channel information of the second channel, and the second signal transmitted over the second channel carries the channel information of the first channel and the channel information of the second channel.

In some embodiments, in the configuration information, configuration of the first signal is the same as or different from configuration of the second signal. In some embodiments, time domain information of the first signal is different from time domain information of the second signal, and another configuration of the first signal is the same as another configuration of the second signal. Alternatively, frequency domain information of the first signal is different from frequency domain information of the second signal, and another configuration of the first signal is the same as another configuration of the second signal. Alternatively, code domain information of the first signal is different from code domain information of the second signal, and another configuration of the first signal is the same as another configuration of the second signal. Alternatively, spatial information of the first signal is different from spatial information of the second signal, and another configuration of the first signal is the same as another configuration of the second signal. Alternatively, time domain information, frequency domain information, code domain information, and spatial information of the first signal are different from time domain information, frequency domain information, code domain information, and spatial information of the second signal.

In some embodiments, the first signal and the second signal are transmitted simultaneously, or are transmitted within a first time interval. In some embodiments, the first time interval is predefined by the standard protocol, configured by a network device, determined autonomously by the first node, or configured by the second node for the first node.

The spatial information may be understood as spatial domain information, spatial relationship, beam information, or the like. The spatial information is indicated by a transmission configuration indication (TCI). Quasi co-location (QCL) information carried in the TCI indicates beam information corresponding to the signal.

In some embodiments, the channel information is channel-state information (CSI), for example, not quantified CSI measured by the first node.

In some embodiments, the channel information of the first channel includes at least one of an amplitude, a phase, a Doppler shift, or a multipath delay. The Doppler shift indicates a change of phase and frequency due to propagation distance difference in the case that the node moves in a direction at a constant speed. The multipath delay indicates an interference delay effect caused by multipath transmission in an electromagnetic wave propagation channel.

For example, the channel information of the first channel is CSI of the first channel, and includes information of the amplitude, the phase, the Doppler shift, and the multipath delay. Using the amplitude and/or the phase as an example, the second signal is modulated based on the amplitude of the first channel, the phase of the first channel, or the amplitude and the phase of the first channel.

In some embodiments, the configuration information is autonomously configured by the first node, and is for configuring a resource of the set of signals. For example, the first node is a base station. In some embodiments, the first node receives the configuration information, and the configuration information is for configuring a resource of the set of signals. In some embodiments, the configuration information is from the second node or another node, the second node is a network device or a terminal, and the another node is a router, a power supply device, a peer device, a network device, or the like.

In some embodiments, the configuration information includes at least one of: configuration of the first signal; or configuration of the second signal.

In some embodiments, the configuration includes at least one of: sequence information, such as sequence identity (ID), or the like; port information, such as at least one of a port number, a port index, or the like; a time domain resource, such as at least one of a period, a slot offset, a start symbol in a time domain, a symbol number of the time domain, a repetition number, or the like; a frequency domain resource, such as at least one of a comb parameter, a comb index (offset), a loop shift, a start resource (such as a resource block (RB)), a bandwidth, a frequency hopping parameter, or the like; a code domain resource, such as an orthogonal code, for example, the first signal is coded using a first orthogonal code, the second signal is coded using a second orthogonal code, and the first orthogonal code and the second orthogonal code are codes orthogonal to each other; power information, such as at least one of a power compensation coefficient, a target power, a circuit loss reference signal, a closed-loop power control mode, or the like; or spatial information, such as at least one of beam information, a carrier ID, a type of an associated signal, an index of an associated signal, or the like. The associated signal indicates a signal associated with the first signal and/or the second signal. For example, in the case that the first signal and/or the second signal is an SRS signal, the first signal and/or the second signal is associated with an SSB, a channel state-reference signal (CS-RS), and the like. The association herein indicates that the SRS and the SSB are transmitted over a same beam or a same beam pair, and the same beam pair includes a transmit beam and a receive beam.

In the embodiments of the present disclosure, a configuration mode of the first signal and the second signal includes repetitive configuration and independent configuration.

In some embodiments, the set of signals is a set of repetitive signals. The first signal and the second signal are two signals in the set of repetitive signals. That is, configuration of the first signal is the same as configuration of the second signal in the configuration information.

In some embodiments, configuration of the first signal and configuration of the second signal are independently configured. That is, configuration of the first signal and configuration of the second signal in the configuration information are partially different or completely different.

In some embodiments, configuration of the first signal and/or the second signal is explicitly indicated or implicitly indicated. For example, in the case that the first signal and the second signal are a set of repetitive signals, an explicit configuration mode is used; and in the case that the first signal and the second signal are independently configured, an implicit configuration mode is used.

In some embodiments, the configuration information indicates at least one of: sequence information of the first signal is the same as sequence information of the second signal; sequence information of the first signal is different from sequence information of the second signal; port information of the first signal is the same as port information of the second signal; port information of the first signal is different from port information of the second signal; a frequency domain resource of the first signal is the same as a frequency domain resource of the second signal; spatial information of the first signal is the same as spatial information of the second signal; power information of the first signal is the same as power information of the second signal; an interval between a time domain resource of the first signal and a time domain resource of the second signal is less than a first threshold; or a time domain resource of the first signal is the same as a time domain resource of the second signal, and a code domain resource of the first signal is different from a code domain resource of the second signal.

In some embodiments, the frequency domain resource of the first signal is the same as the frequency domain resource of the second signal. For example, a physical resource block, or a transmission bandwidth and an original physical resource block of the first signal is the same as a physical resource block, or a transmission bandwidth and an original physical resource block of the second signal. For example, a physical resource block, or a transmission bandwidth and an original physical resource block, and a subcarrier number of the first signal are the same as a physical resource block, or a transmission bandwidth and an original physical resource block, and a subcarrier number of the second signal.

In some embodiments, beam information of the first signal is the same as beam information of the second signal. For example, an index of a transmission configuration indicator of the first signal is the same as an index of a transmission configuration indicator of the second signal. For example, a type of an associated signal and an index of the first signal is the same as a type of an associated signal and an index of the second signal.

In some embodiments, an interval between a time domain resource of the first signal and a time domain resource of the second signal is less. For example, the first signal and the second signal are on adjacent symbols in a same slot. For example, the first signal and the second signal are in a same slot. For example, an interval between a time domain resource of the first signal and a time domain resource of the second signal is less than m symbols, and the m symbols are determined by a network device based on a moving sped of the UE to ensure that the interval between the first signal and the second signal is not greater than an associated time.

In some embodiments, the time domain resource, the frequency domain resource, the power information, and the beam information of the first signal are the same as the time domain resource, the frequency domain resource, the power information, and the beam information of the second signal, and the first signal and the second signal both use orthogonal codes. That is, the code domain resource of the first signal is different from the code domain resource of the second signal.

In some embodiments, the configuration information is configured with or includes configuration of the first signal and/or the second signal, and also includes a base sequence. Elements of the base sequence are all 1, a sequence of real numbers (such as a gold sequence), or a sequence of complex numbers (for example, a real part and an imaginary part are generated by a gold sequence).

In summary, in the method according to the embodiments of the present disclosure, compared with a feedback mode of transmitting signaling carrying quantitated channel information in some practices, the channel information of the first channel is fed back by a channel modulation signal in the present disclosure. Thus, the channel information of the first channel is modulated in a second signal, such that lossless channel information feedback is achieved. In addition, the channel information of the first channel is fed back only based on the time domain resource occupied by the first signal and the second signal, without feedback of a plurality of quantitated bits and additional transmission resources due to reusage of the time domain resource of the first signal and the second signal, such that the resource overhead required for feeding back the channel information is reduced, the feedback cost of the channel information is reduced, and the feedback accuracy and the feedback efficiency of the channel information are improved. In addition, the feedback flexibility of the channel feedback is improved as the two signals are repetitive signals (identical signals) or independently configured signals.

In the communication scenarios, compared with the conventional feedback mode of channel information (for example, measuring the CSI), the method according to the embodiments provide a feedback mode of having more accurate fed back channel information and a lower resource overhead.

In the sensing scenarios, the method according to the embodiments supports wireless sensing of the first node based on the channel information of the first channel. For example, a moving speed of the first node is sensed based on the Doppler shift of the first channel. For example, a distance of the first node is sensed based on the multipath delay of the first channel. For example, an obstacle on a transmission path between the first nodes is sensed (for example, an obstacle is present, an obstacle is removed, or the like) based on a change of channel information of the first channel (for example, a change of amplitude and/or phase) acquired by various measurements. The present disclosure does not limit how the second node uses the channel information of the first channel to achieve the wireless sensing, which can be practiced by the wireless sensing technology in some practices.

As described above, the configuration modes of the first signal and the second signal include at least two modes.

The first mode is repetitive configuration. That is, the configuration of the first signal and the configuration of the second signal are determined based on configuration of the repetitive signal.

The second mode is independent configuration. That is, the first signal and the second signal are two independently configurated signals.

The following describes possible configuration of the first signal and the second signal in the two configuration modes by an example where the first node receives configuration information of a sounding reference signal (SRS).

The First mode is repetitive configuration. That is, the configuration of the first signal and the configuration of the second signal are determined based on configuration of the repetitive signals.

The configuration of the first signal and the configuration of the second signal are identical or the same, or the first signal and the second signal are repetitive signals. Based on the repetitive configuration, the first signal and the second signal are transmitted simultaneously or periodically. In some embodiments, a period value is predefined by the standard protocol, configured by a network device, determined autonomously by the first node, or configured by the second node for the first node.

In some embodiments, the first node receives repetitive configuration of an SRS resource. A repetition number is greater than or equal to 2. Two repetitions respectively correspond to the first signal and the second signal, and the signal being the SRS is used as an example. Using the repetition number being 2 as an example, the configuration of the SRS resource is illustrated, and detailed values are as follows.

| SRS-Resource ::= | SEQUENCE{ |
|---|---|
| SRS-ResourceId | 0, |
| nrofSRS-Ports | ports2 |
| transmissionComb | CHOICE { |
| CombParameter=2 n2 | SEQUENCE { |
| combOffset-n2 | 0 |
| cyclicShift-n2 | 5 |
| }, | |
| }, | |
| resourceMapping | SEQUENCE { |
| startPosition | 0 |
| nrofSymbols | n1 |
| repetitionFactor | 2 |
| }, | |
| freqDomainPosition | 0 |
| freqDomainShift | 0 |
| freqHopping | SEQUENCE { |
| c-SRS | 0 |
| b-SRS | 0 |
| b-hop | 0 |
| }, | |
| resourceType | aperiodic |
| sequenceId | 1000 |
| spatialRelationInfo | SRS-SpatialRelationInfo |
| } | |
| SRS-SpatialRelationInfo ::= | SEQUENCE { |
| servingCellId | 0 |
| referenceSignal | CHOICE { |
| ssb-Index | 0, |

```
      }
  }
```

The Second mode is independent configuration. That is, the first signal and the second signal are two independently configurated signals.

In some embodiments, the first node receives an SRS resource set including at least two SRS resources, that is, the configuration of the first signal and the configuration of the second signal. In some embodiments, the configuration of the first signal and the configuration of the second signal are partially different or completely different.

In some embodiments, configuration of the frequency domain resource and the spatial information of the first signal is the same as configuration of the frequency domain resource and the spatial information of the second signal. Slot configuration of the first signal is the same as slot configuration of the second signal. That is, a period value and a slot offset of the first signal are the same as a period value and a slot offset of the second signal in the case that the first signal and the second signal are periodic or semi-continuous, and a slot offset of the first signal is the same as a slot offset of the second signal in the case that the first signal and the second signal are aperiodic.

In some embodiments, symbol positions (including start symbols) of the first signal and the second signal in the slot are the same, and port indexes of the first signal and the second signal are different. Alternatively, symbol positions (including start symbols) of the first signal and the second signal in the slot are different, and port indexes of the first signal and the second signal are the same or different.

The embodiments are illustrated by an example where the SRS resource set includes two SRS resources corresponding to the first signal and the second signal. The configuration of the first signal is the same as the configuration of the second signal in addition to the start symbols. The SRS resource set is as follows:

| SRS-ResourceSet ::= | SEQUENCE { |
|---|---|
| srs-ResourceSetId | 0, |
| srs-ResourceIdList | 0,1 |
| resourceType | CHOICE { |
| aperiodic | SEQUENCE { |
| slotOffset | 4 |

```
        },
  },
```

| | |
|---|---|
| pathlosscompensationcofficient: alpha | 0.8 |
| targetpower: p0 | 10 |
| pathlossReferenceRS | PathlossReferenceRS-Config |
| srs-PowerControlAdjustmentStates | separateClosedLoop |

}

| | |
|---|---|
| PathlossReferenceRS-Config ::= | CHOICE { |
| ssb-Index | 0, |

}

The configuration of the first signal is as follows:

| SRS-Resource ::= | SEQUENCE { |
|---|---|
| srs-ResourceId | 0, |
| nrofSRS-Ports | ports2 |
| transmissionComb | CHOICE { |
| CombParameter=2 n2 | SEQUENCE { |
| combOffset-n2 | 0 |
| cyclicShift-n2 | 5 |
| }, | |
| }, | |
| resourceMapping | SEQUENCE { |
| startPosition | 0 |
| nrofSymbols | n1 |
| repetitionFactor | n1 |
| }, | |
| freqDomainPosition | 0 |
| freqDomainShift | 0 |
| freqHopping | SEQUENCE { |
| c-SRS | 0 |
| b-SRS | 0 |
| b-hop | 0 |
| }, | |
| resourceType | aperiodic |
| sequenceId | 1000 |
| spatialRelationInfo | SRS-SpatialRelationInfo |
| } | |
| SRS-SpatialRelationInfo ::= | SEQUENCE { |
| servingCellId | 0 |
| referenceSignal | CHOICE { |
| ssb-Index | 0, |

```
      }
  }
```

The configuration of the second signal is as follows:

| SRS-Resource ::= | SEQUENCE { |
|---|---|
| srs-ResourceId | 0, |
| nrofSRS-Ports | ports2 |
| transmissionComb | CHOICE { |
| CombParameter =2 n2 | SEQUENCE { |
| combOffset-n2 | 0 |
| cyclicShift-n2 | 5 |
| }, | |
| }, | |
| resourceMapping | SEQUENCE { |
| startPosition | 1 |
| nrofSymbols | n1 |
| repetitionFactor | n1 |
| }, | |
| freqDomainPosition | 0 |
| freqDomainShift | 0 |
| freqHopping | SEQUENCE { |
| c-SRS | 0 |
| b-SRS | 0 |
| b-hop | 0 |
| }, | |
| resourceType | aperiodic |
| sequenceId | 1000 |
| spatialRelationInfo | SRS-SpatialRelationInfo |
| } | |
| SRS-SpatialRelationInfo ::= | SEQUENCE { |
| servingCellId | 0 |
| referenceSignal | CHOICE { |
| ssb-Index | 0, |

```
      }
  }
```

The embodiments are illustrated by an example where the SRS resource set includes two SRS resources corresponding to the first signal and the second signal. The configuration of the first signal is the same as the configuration of the second signal in addition to the SRS port indexes. The SRS resource set is as follows:

| SRS-ResourceSet ::= | SEQUENCE { |
|---|---|
| srs-ResourceSetId | 0, |
| srs-ResourceIdList | 0,1 |
| resourceType | CHOICE { |
| aperiodic | SEQUENCE { |
| slotOffset | 4 |

```
    },
  },
```

| | |
|---|---|
| pathlosscompensationcofficient: alpha | 0.8 |
| targetpower: p0 | 10 |
| pathlossReferenceRS | PathlossReferenceRS-Config |
| srs-PowerControlAdjustmentStates | separateClosedLoop |

}

| | |
|---|---|
| PathlossReferenceRS-Config ::= | CHOICE { |
| ssb-Index | 0, |

}

The configuration of the first signal is as follows:

| SRS-Resource ::= | SEQUENCE { |
|---|---|
| srs-ResourceId | 0, |
| nrofSRS-Ports | ports2 |
| transmissionComb | CHOICE { |
| CombParamter=2 n2 | SEQUENCE { |
| combOffset-n2 | 0 |
| cyclicShift-n2 | 0 |
| }, | |
| }, | |
| resourceMapping | SEQUENCE { |
| startPosition | 0 |
| nrofSymbols | n1 |
| repetitionFactor | n1 |
| }, | |
| freqDomainPosition | 0 |
| freqDomainShift | 0 |
| freqHopping | SEQUENCE { |
| c-SRS | 0 |
| b-SRS | 0 |
| b-hop | 0 |
| }, | |
| resourceType | aperiodic |
| sequenceId | 1000 |
| spatialRelationInfo | SRS-SpatialRelationInfo |
| } | |
| SRS-SpatialRelationInfo ::= | SEQUENCE { |
| servingCellId | 0 |
| referenceSignal | CHOICE { |
| ssb-Index | 0, |

```
      }
  }
```

The configuration of the second signal is as follows:

| SRS-Resource ::= | SEQUENCE { |
|---|---|
| srs-ResourceId | 0, |
| nrofSRS-Ports | ports2 |
| transmissionComb | CHOICE { |
| CombParamter =2 n2 | SEQUENCE { |
| combOffset-n2 | 0 |
| cyclicShift-n2 | 2 |
| }, | |
| }, | |
| resourceMapping | SEQUENCE { |
| startPosition | 1 |
| nrofSymbols | n1 |
| repetitionFactor | n1 |
| }, | |
| freqDomainPosition | 0 |
| freqDomainShift | 0 |
| freqHopping | SEQUENCE { |
| c-SRS | 0 |
| b-SRS | 0 |
| b-hop | 0 |
| }, | |
| resourceType | aperiodic |
| sequenceId | 1000 |
| spatialRelationInfo | SRS-SpatialRelationInfo |
| SRS-SpatialRelationInfo ::= | SEQUENCE { |
| servingCellId | 0 |
| referenceSignal | CHOICE { |
| ssb-Index | 0, |

```
      }
  }
```

It is understandable that the configuration information and the value are illustrated, which are not limited in the embodiments.

In the embodiments of the present disclosure, the second signal is transmitted upon modulation based on channel information of a first channel by at least the modulation modes based on the amplitude and/or the phase in the channel information of the first channel. The modulation modes include following three types of modes:
type 1, modulation based on the amplitude of the first channel;
type 2, modulation based on the phase of the first channel; and
type 3, modulation based on the amplitude and the phase of the first channel.

### Type 1: Modulation Based on the Amplitude of the First Channel

FIG. 7 is a schematic flowchart of a method for wireless communication according to some embodiments of the present disclosure. The embodiments are described by an example where the second signal is transmitted upon modulation based on the amplitude of the first channel, and the configuration of the first signal is the same as the configuration of the second signal in the configuration information in the method. That is, the configuration of the first signal and the configuration of the second signal are identical.

In S701, a first node modulates a second signal based on an amplitude of a first channel.

In S703, a first node transmits the first signal and the second signal.

In the embodiments, the configuration information includes a base sequence of the first signal and a base sequence of the second signal, the base sequence (a sequence for short hereinafter) of the first signal is the same as the base sequence of the second signal, that is, S=[s_0, s_1, . . . s_(L−2), s_(L−1)]. L is a length of the sequence of the first signal and a length of the sequence of the second signal.

The embodiments are illustrated by an example where the first channel is a channel from the second node to the first node and the second channel is a channel from the first node to the second node. is It assumed that the sequence of the first channel

$$H = [ {a}_{0} {e}^{- {w}_{0}} , {a}_{1} {e}^{- {w}_{1}} , … {a}_{N - 2} {e}^{- {w}_{{N}_{c} - 2}} , {a}_{N - 1} {e}^{- {w}_{{N}_{c} - 1}} ] ,$$

Nc is a number of frequency domain units corresponding to the first channel, the amplitude of the first channel is A=[a₀, a₁, . . . a_{L-2}, a_{L-1}], and the phase of the first channel is

$$B = [ {e}^{- {w}_{0}} , {e}^{- {w}_{1}} , … {e}^{- {w}_{{N}_{c} - 2}} , {e}^{- {w}_{{N}_{c} - 1}} ] .$$

The frequency domain unit is any of a sub-band, a sub-carrier, and a physical resource block, and the embodiments are illustrated by an example where the frequency domain unit is the sub-carrier.

The first signal is transmitted by the first node to the second node based on the configuration information, and the second signal is transmitted to the second node in the case that L second sequence elements are modulated by the first node based on the configuration information and amplitudes corresponding to all or part of the Nc first sequence elements in the first channel.

Sequence elements in the sequence of the first channel are the first sequence elements, sequence elements in the base sequence of the configured second signal are the second sequence elements, sequence elements in the sequence of the second signal transmitted by the first node are third sequence elements, and the third sequence elements are acquired by modulating the second sequence elements based on the amplitudes corresponding to the first sequence elements.

In some embodiments, L=Nc, and an i^{th} second sequence element in the L second sequence elements is modulated based on an amplitude corresponding to an i^{th} sequence element in the Nc first sequence elements. i is an integer not greater than L or Nc. That is, i is an integer less than or equal to L, and i is an integer less than or equal to Nc. Illustratively, the sequence of the transmitted second signal is S1=[s₀a₀, s₁a₁, . . . s_{L-2}a_{Nc-2}, s_{L-1}a_{Nc-1}].

In some embodiments, L>Nc, and L third sequence elements in the transmitted second signal are acquired by repeatedly carrying all or part of the Nc sequence elements in the first channel by the L second sequence elements. That is, at least two second sequence elements in the L second sequence elements are modulated based on an amplitude corresponding to a j^{th} first sequence element in the N_{c} first sequence elements. j is an integer less than or equal to N_{c}. Illustratively, the sequence of the transmitted second signal is S1=[s₀a₀, s₁a₀, s₂a₁ . . . s_{L-2}a_{Nc-1}, s_{L-1}a_{Nc-1}].

In some embodiments, L>Nc, and L third sequence elements in the transmitted second signal are acquired by modulating K second sequence elements in the L second sequence elements based on the amplitudes corresponding to Nc first sequence elements. In some embodiments, the K second sequence elements are acquired by sampling from the L second sequence elements, by selecting from the L second sequence elements based on a selection rule, or selecting from the L second sequence elements based on a pseudo-stochastic algorithm. K is a positive integer less than or equal to Nc. Illustratively, the sequence of the transmitted second signal is S1=[s₀a₀, s₁a₁, s₂a₂, . . . s_{L-2}a_{Nc-2}, s_{L-1}a_{Nc-1}].

In some embodiments, L<Nc, and L third sequence elements in the transmitted second signal are for carrying part of the Nc sequence elements in the first channel. That is, the L second sequence elements are modulated based on the amplitudes corresponding to M first sequence elements in the Nc first sequence elements. M is a positive integer less than or equal to L. In some embodiments, the M first sequence elements are sampled from the Nc first sequence elements, selected from the Nc first sequence elements based on a selection rule, or selected from the Nc first sequence elements based on a pseudo-stochastic algorithm. The sampling mode includes, for example, equal interval sampling, intercepting a channel sequence on part of a bandwidth, and the like, and the embodiments of the present disclosure do not limit the specific sampling mode. Illustratively, using L being 4, Nc being 7, and M being 4 as an example, four first sequence elements corresponding to a0, a2, a4, and a6 are sampled at equal intervals, and thus the sequence of the transmitted second signal is S1=[s₀a₀, s₁a₂, s₂a₄, s₃a₆]; or, four first sequence elements corresponding to a2, a3, a4, and a5 are intercepted on part of the bandwidth, and thus the sequence of the transmitted second signal is S1=[s₀a₂, s₁a₃, s₂a₄, s₃a₅]; or, the four first sequence elements corresponding to a0, a3, a4, and a6 are sampled according to the pseudo-random algorithm, and thus the sequence of the transmitted second signal is S1=[s₀a₀, s₁a₃, s₂a₄, s₃a₆].

In summary, in the method according to the embodiments of the present disclosure, the first signal and the second signal modulated based on the amplitude of the first channel are transmitted based on the configuration information, such that the second node accurately acquires amplitude information of the first channel and information of the second channel, the resource overhead of the channel feedback is reduced, and the flexibility of the channel feedback is improved.

### Type 2: Modulation Based on the Phase of the First Channel

FIG. 8 is a schematic flowchart of a method for wireless communication according to some embodiments of the present disclosure. The embodiments are described by an example where the second signal is transmitted upon modulation based on the phase of the first channel and the configuration of the first signal is the same the configuration of the second signal in the configuration information in the method. That is, the configuration of the first signal and the configuration of the second signal are identical.

In S801, a first node modulates a second signal based on a phase of a first channel.

In S803, a first node transmits the first signal and the second signal.

In the embodiments, the configuration information includes a base sequence of the first signal and a base sequence of the second signal, the base sequence of the first signal is the same as the base sequence of the second signal, that is, S=[s_0, s_1, . . . s_(L−2), s_(L−1)]. L is a length of the sequence of the first signal and a length of the sequence of the second signal.

The embodiments are illustrated by an example where the first channel is a channel from the second node to the first node and the second channel is a channel from the first node to the second node. It is assumed that the sequence of the first channel

$$H = [ {a}_{0} {e}^{- {w}_{0}} , {a}_{1} {e}^{- {w}_{1}} , … {a}_{Nc - 2} {e}^{- {w}_{Nc - 2}} , {a}_{Nc - 1} {e}^{- {w}_{Nc - 1}} ] ,$$

Nc is a number of frequency domain units corresponding to the first channel, the amplitude of the first channel is A=[a₀, a₁, . . . a_{L-2}, a_{L-1}], and the phase of the first channel is

$$B = [ {e}^{- {w}_{0}} , {e}^{- {w}_{1}} , … {e}^{- {w}_{{N}_{c} - 2}} , {e}^{- {w}_{{N}_{c} - 1}} ] .$$

The frequency domain unit is any of a sub-band, a sub-carrier, and a physical resource block, and the embodiments are illustrated by an example where the frequency domain unit is the sub-carrier.

The first signal is transmitted by the first node to the second node based on the configuration information, and the second signal is transmitted to the second node in the case that L second sequence elements are modulated by the first node based on the configuration information and phases corresponding to all or part of the Nc first sequence elements in the first channel.

Sequence elements in the sequence of the first channel are the first sequence elements, sequence elements in the base sequence of the configured second signal are the second sequence elements, sequence elements in the sequence of the second signal transmitted by the first node are third sequence elements, and the third sequence elements are acquired by modulating the second sequence elements based on the phases corresponding to the first sequence elements. In some embodiments, L=Nc, and an i^{th} second sequence element in the L second sequence elements is modulated based on a phase corresponding to an i^{th} sequence element in the Nc first sequence elements. i is an integer not greater than L or N_{c}. That is, i is an integer less than or equal to L, and i is an integer less than or equal to N_{c}. Illustratively, the sequence of the transmitted second signal is s₀e^{-w}^{₀}, s₁e^{-w}^{₁}, . . . s_{L-2}e^{-w}^{_{Nc-2}}, s_{L-1}e^{-w}^{_{Nc-1}}.

In some embodiments, L>Nc, and L third sequence elements in the transmitted second signal are acquired by repeatedly carrying all or part of the Nc sequence elements in the first channel by the L second sequence elements. That is, at least two second sequence elements in the L second sequence elements are modulated based on a phase corresponding to a j^{th} first sequence element in the N_{c} first sequence elements. j is an integer less than or equal to N_{c}. Illustratively, the sequence of the transmitted second signal is S1=[s₀e^{-w}^{₀}, s₁e^{-w}^{₀}, s₂e^{-w}^{₁}, s₃e^{-w}^{₁}, . . . s_{L-2}e^{-w}^{_{Nc-1}}, s_{L-1}e^{-w}^{_{Nc-1}}].

In some embodiments, L>Nc, and L third sequence elements in the transmitted second signal are acquired by modulating K second sequence elements in the L second sequence elements based on the phases corresponding to Nc first sequence elements. In some embodiments, the K second sequence elements are sampled from the L second sequence elements, selected the L second sequence elements based on a selection rule, or selected from the L second sequence elements based on a pseudo-stochastic algorithm. K is a positive integer less than or equal to Nc. Illustratively, the sequence of the transmitted second signal is S1=[s₀e^{-w}^{₀}, s₁e^{-w}^{₁}, s₂e^{-w}^{₂}, s₃e^{-w}^{₃}, . . . s_{L-2}e^{-w}^{_{Nc-2}}, s_{L-1}e^{-w}^{_{Nc-1}}].

In some embodiments, L<Nc, and L third sequence elements in the transmitted second signal are for carrying part of the Nc sequence elements in the first channel. That is, the L second sequence elements are modulated based on the phases corresponding to M first sequence elements in the Nc first sequence elements. M is a positive integer less than or equal to L. In some embodiments, the M first sequence elements are acquired by sampling from the Nc first sequence elements, by selecting from the Nc first sequence elements based on a selection rule, or selecting from the Nc first sequence elements based on a pseudo-stochastic algorithm. The sampling mode includes, for example, equal interval sampling, intercepting a channel sequence on part of a bandwidth, and the like, and the embodiments of the present disclosure do not limit the specific sampling mode. Illustratively, using L being 4, Nc being 7, and M being 4 as an example, four first sequence elements corresponding to a0, a2, a4, and a6 are sampled at equal intervals, and thus the sequence of the transmitted second signal is S1=[s₀e^{-w}^{₀}, s₁e^{-w}^{₂}, s₂e^{-w}^{₄}, s₃e^{-w}^{₆}]; or, four first sequence elements corresponding to a2, a3, a4, and a5 are intercepted on part of the bandwidth, and thus the sequence of the transmitted second signal is S1=[s₀e^{-w}^{₂}, s₁e^{-w}^{₃}, s₂e^{-w}^{₄}, s₃e^{-w}^{₅}]; or, the four first sequence elements corresponding to a0, a3, a4, and a6 are sampled according to the pseudo-random algorithm, and thus the sequence of the transmitted second signal is S1=[s₀e^{-w}^{₀}, s₁e^{-w}^{₃}, s₂e^{-w}^{₄}, s₃e^{-w}^{₆}].

In summary, in the method according to the embodiments of the present disclosure, the first signal and the second signal modulated based on the phase of the first channel are transmitted based on the configuration information, such that the second node accurately acquires phase information of the first channel and information of the second channel, the resource overhead of the channel feedback is reduced, and the flexibility of the channel feedback is improved.

### Type 3: Modulation Based on the Amplitude and the Phase of the First Channel

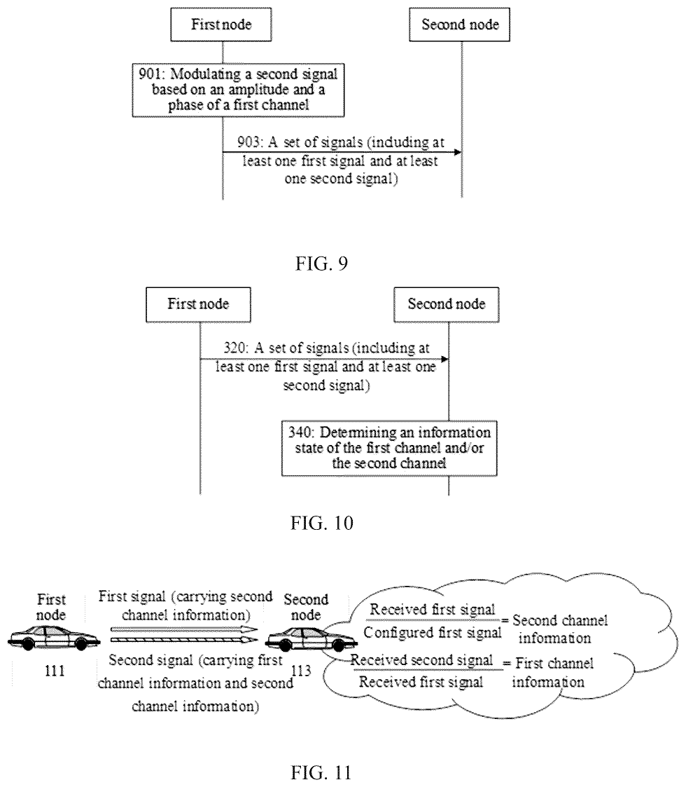

FIG. 9 is a schematic flowchart of a method for wireless communication according to some embodiments of the present disclosure. The embodiments are described by an example where the second signal is transmitted upon modulation based on the amplitude and the phase of the first channel, and the configuration of the first signal is the same as the configuration of the second signal in the configuration information in the method. That is, the configuration of the first signal and the configuration of the second signal are identical.

In S901, a first node modulates a second signal based on an amplitude and a phase of a first channel.

In S903, a first node transmits the first signal and the second signal.

In the embodiments, the configuration information includes a base sequence of the first signal and a base sequence of the second signal, the base sequence of the first signal is the same as the base sequence of the second signal, that is, S=[s_0, s_1, . . . s_(L−2), s_(L−1)]. L is a length of the sequence of the first signal and a length of the sequence of the second signal.

The embodiments are illustrated by an example where the first channel is a channel from the second node to the first node and the second channel is a channel from the first node to the second node. It is assumed that the sequence of the first channel

$$H = [ {a}_{0} {e}^{- {w}_{0}} , {a}_{1} {e}^{- {w}_{1}} , … {a}_{N - 2} {e}^{- {w}_{Nc - 2}} , {a}_{N - 1} {e}^{- {w}_{Nc - 1}} ] ,$$

Nc is a number of frequency domain units corresponding to the first channel, the amplitude of the first channel is A=[a₀, a₁, . . . a_{L-2}, a_{L-1}], and the phase of the first channel is

$$B = [ {e}^{- {w}_{0}} , {e}^{- {w}_{1}} , … {e}^{- {w}_{{N}_{c} - 2}} , {e}^{- {w}_{{N}_{c} - 1}} ] .$$

The frequency domain unit is any of a sub-band, a sub-carrier, and a physical resource block, and the embodiments are illustrated by an example where the frequency domain unit is the sub-carrier.

The first signal is transmitted by the first node to the second node based on the configuration information, and the second signal is transmitted to the second node in the case that L second sequence elements are modulated by the first node based on the configuration information and amplitudes and phases corresponding to all or part of the Nc first sequence elements in the first channel.

Sequence elements in the sequence of the first channel are the first sequence elements, sequence elements in the base sequence of the configured second signal are the second sequence elements, sequence elements in the sequence of the second signal transmitted by the first node are third sequence elements, and the third sequence elements are acquired by modulating the second sequence elements based on the amplitudes and phases corresponding to the first sequence elements.

In some embodiments, L=Nc, and an i^{th} second sequence element in the L second sequence elements is modulated based on an amplitude and a phase corresponding to an i^{th} sequence element in the Nc first sequence elements. i is an integer not greater than L or N_{c}. That is, i is an integer less than or equal to L, and i is an integer less than or equal to N_{c}. Illustratively, the sequence of the transmitted second signal is S1=[s₀×a₀e^{-w}^{₀}, s₁×a₁e^{-w}^{₁}, . . . s_{L-2}×a_{Nc-2}e^{-w}^{_{Nc-2}}, s_{L-1}×a_{Nc-1}e^{-w}^{_{NC-1}}].

In some embodiments, L>Nc, and L third sequence elements in the transmitted second signal are acquired by repeatedly carrying all or part of the Nc sequence elements in the first channel by the L second sequence elements. That is, at least two second sequence elements in the L second sequence elements are modulated based on an amplitude and a phase corresponding to a j^{th} first sequence element in the N_{c} first sequence elements. j is an integer less than or equal to Nc. Illustratively, the sequence of the transmitted second signal is S1=[s₀×a₀e^{-w}^{₀}, s₁×a₀e^{-w}^{₀}, s₂×a₁e^{-w}^{₁}, s₃×a₁e^{-w}^{₁} . . . s_{L-2}×a_{Nc-1}e^{-w}^{_{Nc-1}}, s_{L-1}×a_{Nc-1}e^{-w}^{_{Nc-1}}].

In some embodiments, L>Nc, and L third sequence elements in the transmitted second signal are acquired by modulating K second sequence elements in the L second sequence elements based on the amplitudes and the phases corresponding to Nc first sequence elements. In some embodiments, the K second sequence elements are sampled from the L second sequence elements, selected from the L second sequence elements based on a selection rule or selected from the L second sequence elements based on a pseudo-stochastic algorithm. K is a positive integer less than or equal to Nc. Illustratively, the sequence of the transmitted second signal is S1=[s₀×a₀e^{-w}^{₀}, s₁×a₁e^{-w}^{₁}, s₂×a₂e^{-w}^{₂}, s₃×a₃e^{-w}^{₃}, . . . s_{L-2}×a_{Nc-2}e^{-w}^{_{Nc-2}}, s_{L-1}×a_{Nc-1}e^{-w}^{_{Nc-1}}].

In some embodiments, L<Nc, and L third sequence elements in the transmitted second signal are for carrying part of the Nc sequence elements in the first channel. That is, the L second sequence elements are modulated based on the amplitudes and the phases corresponding to M first sequence elements in the Nc first sequence elements. M is a positive integer less than or equal to L. In some embodiments, the M first sequence elements are sampled from the Nc first sequence elements, selected from the Nc first sequence elements based on a selection rule or selected from the Nc first sequence elements based on a pseudo-stochastic algorithm. The sampling mode includes, for example, equal interval sampling, intercepting a channel sequence on part of a bandwidth, and the like, and the embodiments of the present disclosure do not limit the specific sampling mode. Illustratively, using L being 4, Nc being 7, and M being 4 as an example, four first sequence elements corresponding to a0, a2, a4, and a6 are sampled at equal intervals, and thus the sequence of the transmitted second signal is S1=[s₀×a₀e^{-w}^{₀}, s₁×a₂e^{-w}^{₂}, s₂×a₄e^{-w}^{₄}, s₃×a₆e^{-w}^{₆}]; or, four first sequence elements corresponding to a2, a3, a4, and a5 are intercepted on part of the bandwidth, and thus the sequence of the transmitted second signal is S1=[s₀×a₂e^{-w}^{₂}, s₁×a₃e^{-w}^{₃}, s₂×a₄e^{-w}^{₄}, s₃×a₅e^{-w}^{₅}]; or, the four first sequence elements corresponding to a0, a3, a4, and a6 are sampled according to the pseudo-random algorithm, and thus the sequence of the transmitted second signal is S1=[s₀×a₀e^{-w}^{₀}, s₁×a3e^{-w}^{₃}, s₂×a₄e^{-w}^{₄},s₃×a₆e^{-w}^{₆}].

In summary, in the method according to the embodiments of the present disclosure, the first signal and the second signal modulated based on the amplitude and the phase of the first channel are transmitted based on the configuration information, such that the second node accurately acquires amplitude information of the first channel and information of the second channel, the resource overhead of the channel feedback is reduced, and the flexibility of the channel feedback is improved.

FIG. 10 is a schematic flowchart of a method for wireless communication according to some embodiments of the present disclosure. The method according to the embodiments are applicable to a second node, and includes at least part of following processes.

In S320, a set of signals transmitted by a first node is received, wherein the set of signals includes at least one first signal and at least one second signal.

The set of signals is periodic, aperiodic, or semi-continuous.

The first signal is transmitted by the first node based on configuration information, and the second signal is transmitted by the first node over a first channel upon modulation. That is, the first signal is not modulated based on the channel information of the first channel, and the second signal is modulated based on the channel information of the first channel. The first signal and the second signal are transmitted based on the configuration information. In the case that the configuration information includes configuration of the first signal and configuration of the second signal, the first signal is transmitted based on the configuration of the first signal, and the second signal is transmitted based on the configuration of the second signal. The second signal is additionally modulated based on the channel information of the first channel and transmitted.

The first node transmits a set of signals to the second node. In some embodiments, the first channel is a channel from the second node to the first node. Alternatively, the first channel is a channel from another node to the first node, for example, a channel from the third node to the first node. Alternatively, the first channel is a channel from the second node to another node, for example, a channel from the second node to the third node. Alternatively, the first channel is a channel from the fourth node to the third node.

The second channel is a channel from the first node to the second node. The first signal is transmitted over the second channel based on the configuration information without modulation through the first channel, and the second signal is transmitted over the second channel based on the configuration information upon modulation based on the channel information of the first channel. Thus, the first signal carries the channel information of the second channel, and the second signal carries the channel information of the first channel and the channel information of the second channel.

In some embodiments, in the configuration information, the configuration of the first signal is the same as or different from the configuration of the second signal. Illustratively, the time domain information of the first signal is different from the time domain information of the second signal, and another configuration of the first signal is the same as another configuration of the second signal. Alternatively, the frequency domain information of the first signal is different from the frequency domain information of the second signal, and another configuration of the first signal is the same as another configuration of the second signal. Alternatively, the code domain information of the first signal is different from the code domain information of the second signal, and another configuration of the first signal is the same as another configuration of the second signal. Alternatively, the spatial information of the first signal is different from the spatial information of the second signal, and another configuration of the first signal is the same as another configuration of the second signal. Alternatively, the time domain information, the frequency domain information, the code domain information, and the spatial information of the first signal are different from the time domain information, the frequency domain information, the code domain information, and the spatial information of the second signal.

The spatial information indicates spatial domain information, spatial relationship, beam information, and the like. The spatial information is indicated by TCI. QCL information carried in the TCI indicates beam information corresponding to the signal.

In some embodiments, the channel information is CSI, for example, not quantified CSI measured by the first node.

In some embodiments, the channel information of the first channel includes at least one of an amplitude, a phase, a Doppler shift, or a multipath delay.

Using the Doppler shift as an example, the second signal is modulated based on an amplitude of the first channel, a phase of the first channel, or an amplitude and a phase of the first channel.

In some embodiments, the configuration information is transmitted by the second node for the first node, and is for configuring a resource of the set of signals.

In some embodiments, the configuration information is transmitted by another node to the first node. The another node is a router, a power supply device, a peer device, a network device, and the like.

In some embodiments, the configuration information is autonomously configured by the first node, and is for configuring a resource of the set of signals. For example, the first node is a base station.

In some embodiments, the configuration information includes at least one of: configuration of the first signal; or configuration of the second signal.

In some embodiments, the configuration includes at least one of: sequence information, such as sequence ID, and the like; port information, such as at least one of a port number, a port index, or the like; a time domain resource, such as at least one of a period, a slot offset, a start symbol in a time domain, a symbol number of the time domain, a repetition number, or the like; a frequency domain resource, such as at least one of a comb parameter, a comb index (offset), a loop shift, a start resource (such as an RB), a bandwidth, a frequency hopping parameter, or the like; a code domain resource, such as an orthogonal code, for example, the first signal is coded using a first orthogonal code, the second signal is coded using a second orthogonal code, and the first orthogonal code and the second orthogonal code are codes orthogonal to each other; power information, such as at least one of a power compensation coefficient, a target power, a circuit loss reference signal, a closed-loop power control mode, or the like; or spatial information, such as at least one of beam information, a carrier ID, a type of an associated signal, an index of an associated signal, or the like.

In some embodiments, the set of signals is a set of repetitive signals. The first signal and the second signal are two signals in the set of repetitive signals. That is, configuration of the first signal is the same as configuration of the second signal in the configuration information.

In some embodiments, configuration of the first signal and configuration of the second signal are independently made. That is, configuration of the first signal and configuration of the second signal in the configuration information are partially different or completely different.

In some embodiments, the configuration information indicates at least one of: sequence information of the first signal is the same as sequence information of the second signal; sequence information of the first signal is different from sequence information of the second signal; port information of the first signal is the same as port information of the second signal; port information of the first signal is different from port information of the second signal; a frequency domain resource of the first signal is the same as a frequency domain resource of the second signal; spatial information of the first signal is the same as spatial information of the second signal; power information of the first signal is the same as power information of the second signal; an interval between a time domain resource of the first signal and a time domain resource of the second signal is less than a first threshold; or a time domain resource of the first signal is the same as a time domain resource of the second signal, and a code domain resource of the first signal is different from a code domain resource of the second signal.

In S340, channel information of the first channel and/or the second channel is determined.

In some embodiments, the channel information of the first channel is determined based on the second signal and the first signal.

In some embodiments, the channel information of the first channel is determined based on the second signal, the first signal, and a first operation mode.

In some embodiments, the first operation mode includes at least one of: dividing the second signal by the first signal, or conjugately multiplying the second signal by the first signal.

In some embodiments, the channel information of the first channel is determined based on a quotient of the second signal and the first signal. Alternatively, the channel information of the first channel is determined by multiplying the second signal by the conjugate of the second signal.

In some embodiments, the second node determines the channel information of the first channel based on the received second signal and the received first signal.

In some embodiments, the channel information of the second channel is determined based on the first signal, a base sequence of the first signal, and a second operation mode.

In some embodiments, the second operation mode includes at least one of: dividing the first signal by the base sequence of the first signal, or conjugately multiplying the first signal by the base sequence of the first signal.

In some embodiments, the channel information of the first channel is determined based on a quotient of the second signal and the first signal. Alternatively, the channel information of the first channel is determined by multiplying the second signal by the conjugate of the second signal.

In some embodiments, the channel information of the first channel is determined by dividing the received second signal by the received first signal. Alternatively, the channel information of the first channel is determined by conjugately multiplying the received second signal by the received first signal.

In some embodiments, the channel information of the second channel is determined based on the first signal.

In some embodiments, the second node determines the channel information of the second channel based on the received first signal and the first signal configured in the configuration information.

In some embodiments, the channel information of the second channel is determined based on a quotient of the received first signal and the first signal configured in the configuration information, or, the channel information of the second channel is determined by conjugately multiplying the received first signal by the first signal configured in the configuration information. In some embodiments, the channel information of the second channel is determined by dividing the received first signal by the first signal in the configuration information, or, the channel information of the second channel is determined by conjugately multiplying the received first signal by the first signal in the configuration information.

The embodiments are described by an example where the first channel is a channel from the second node to the first node, the second channel is a channel from the first node to the second node, and the configuration of the first signal is the same as the configuration of the second signal in the configuration information. That is, the configuration of the first signal and the configuration of the second signal are identical.

It is assumed that the base sequence of the first signal is the same as the base sequence of the second signal, that is, S=[s₀, s₁, . . . s_{L-2}, s_{L-1}]. L is a length of the sequence of the first signal and a length of the sequence of the second signal.

It is assumed that the sequence of the first channel H1=[a₀e^{-w}^{₀}, a₁e^{-w}^{₁}, . . . a_{Nc-2}e^{-w}^{_{Nc-2}}, a_{Nc-1}e^{-w}^{_{Nc-1}}], Nc is a number of frequency domain units corresponding to the first channel, a is the amplitude of the first channel, and e^{-w} is the phase of the first channel. The frequency domain unit is any of a sub-band, a sub-carrier, and a physical resource block, and the embodiments are illustrated by an example where the frequency domain unit is the sub-carrier.

It is assumed that the sequence of the second channel is H2.

### Determination of the Channel Information of the First Channel:

### 1. Determination of the First Channel by Modulating the Second Signal Based on the Amplitude of the First Channel

In some embodiments, the first signal received by the second node on a first signal resource is Y1=S×H2+N₁. That is, Y1=[s₀×b₀e^{-v}^{₀}, s₁×b₁e^{-v}^{₁}, . . . s_{L-2}×b_{L-2}e^{-v}^{_{L-2}}, s_{L-1}×b_{L-1}e^{-v}^{_{L-1}}]+N₁. The second signal received by the second node on a second signal resource is Y2=S1×H2+N₂. That is, Y2=[s₀×a₀×b₀e^{-v}^{₀}, s₁×a₁×b₁e^{-v}^{₁}, . . . s_{L-2}×a_{L-2}×b_{L-2}e^{-v}^{_{L-2}}, s_{L-1}×a_{L-1}×b_{L-1}e^{-v}^{_{L-1}}]+N₂. N₁ and N₂ are noise. The sequence of the received second signal is divided by the sequence of the received first signal or the sequence of the received second signal is conjugately multiplied by the sequence of the received first signal to acquire the amplitude of the first channel, that is, A1=[a₀, a₁, . . . a_{L-2}, a_{L-1}]+N₁₂′. N₁₂′ is noise. Illustratively, N₁₂′ is a quotient of N₂ and N₁.

### 2. Modulation of the Second Signal Based on the Phase of the First Channel

In some embodiments, the first signal received by the second node on a first signal resource is Y1=S×H2+N₁. That is, Y1=[s₀×b₀e^{-v}^{₀}, s₁×b₁e^{-v}^{₁}, . . . s_{L-2}×b_{L-2}e^{-v}^{_{L-2}}, s_{L-1}×b_{L-1}e^{-v}^{_{L-1}}]+N₁. The second signal received by the second node on a second signal resource is Y2=s₁×H2+N₂. That is, Y2=[s₀×e^{-w}^{₀}×b₀e^{-v}^{₀}, s₁×e^{-w}^{₁}×b₁e^{-v}^{₁}, . . . s_{L-2}×e^{-s}^{_{L-2}}×b_{L-2}e^{-v}^{_{L-2}}, s_{L-1}×e^{-w}^{_{L-1}}×b_{L-1}e^{-v}^{_{L-1}}]+N₂. N₁ and N₂ are noise. The sequence of the received second signal is divided by the sequence of the received first signal or the sequence of the received second signal is conjugately multiplied by the sequence of the received first signal to acquire the phase of the first channel, that is, B1=[e^{-w}^{₀}, e^{-w}^{₁}, . . . e^{-w}^{_{L-2}}, e^{-w}^{_{L-1}}]+N₁₂′. N₁₂′ is noise. Illustratively, N₁₂′ is a quotient of N₂ and N₁.

3. Modulation of the Second Signal Based on the Amplitude and/or the Phase of the First Channel

In some embodiments, the first signal received by the second node on a first signal resource is Y1=S×H2+N₁. That is, Y1=[s₀×b₀e^{-v}^{₀}, s₁×b₁e^{-v}^{₁}, . . . s_{L-2}×b_{L-2}e^{-v}^{_{L-2}}, s_{L-1}×b_{L-1}e^{-v}^{_{L-1}}]+N₁. The second signal received by the second node on a second signal resource is Y2=S1×H2+N₂. That is, Y2=[s₀×a₀e^{-w}^{₀}×b₀e^{-v}^{₀}, s₁×a₁e^{-w}^{₁}×b₁e^{-v}^{₁}, . . . s_{L-2}×a_{L-2}e^{-w}^{_{L-2}}×b_{L-2}e^{-v}^{_{L-2}}, s_{L-1}×a_{L-1}e^{-w}^{_{L-1}}×b_{L-1}e^{-v}^{_{L-1}}]+N₂. N₁ and N₂ are noise. The sequence of the received second signal is divided by the sequence of the received first signal or the sequence of the received second signal is conjugately multiplied by the sequence of the received first signal to acquire the sequence of the first channel, that is, H1′=[a₀e^{-w}^{₀}, a₁e^{-w}^{₁}, . . . a_{Nc-2}e^{-w}^{_{Nc-2}}, a_{Nc-1}e^{-w}^{_{Nc-1}}]+N₁₂′. Nc is a number of frequency domain units corresponding to the first channel, the amplitude of the first channel is A=[a₀, a₁, . . . a_{L-2}, a_{L-1}], and the phase of the first channel is B=[e^{-w}^{₀}, e^{-w}^{₁}, . . . e^{-w}^{_{Nc-2}}, e^{-w}^{_{Nc-1}}]. N₁₂′ is noise. Illustratively, N₁₂′ is a quotient of N₂ and N₁.

### Determination of the Channel Information of the Second Channel:

In some embodiments, the first signal received by the second node on a first signal resource is Y1=S×H2+N₁. That is, Y1=[s₀×b₀e^{-v}^{₀}, s₁×b₁e^{-v}^{₁}, . . . s_{L-2}×b_{L-2}e^{-v}^{_{L-2}}, s_{L-1}×b_{L-1}e^{-v}^{_{L-1}}]+N₁. N₁ and N₂ are noise. The sequence of the received first signal is divided by the base sequence of the first signal in the configuration information or the sequence of the received first signal is conjugately multiplied by the base sequence of the first signal in the configuration information to acquire the sequence of the first channel, that is, H2′=[b₀e^{-v}^{₀}, b₁e^{-v}^{₁}, . . . b_{L-2}e^{-v}^{_{L-2}}, b_{L-1}e^{-v}^{_{L-1}}]+N₁′. N₁′ is noise. Illustratively, N₁′ is a derivative of N₁.

In some embodiments, the sequence of the first channel includes N_{c} first sequence elements, the sequence of the received second signal includes L third sequence elements, and the L third sequence elements in the received second signal are acquired by modulating L second sequence elements in the second signal in the configuration information based on the channel information of all or part of the N_{c} first sequence elements. L is a length of the second signal sequence, and Nc is a number of frequency domain units corresponding to the first channel.

### L=N_{c}

In some embodiments, L=Nc, and an i^{th} second sequence element in the L second sequence elements is modulated based on channel information of an i^{th} sequence element in the N_{c} first sequence elements. i is an integer not greater than L or N_{c}. The second node acquires the channel information of a j^{th} first sequence element upon performing data processing on an i^{th} third sequence element. Illustratively, the second node knows that a third second sequence element in the L second sequence elements is modulated based on channel information of a second first sequence element in the N_{c} first sequence elements, and divides or conjugately multiplies a third sequence element in the L third sequence elements in the received second signal by the third second sequence element in the L second sequence elements in the configuration information to acquire the channel information of the second first sequence element.

### L>N_{c}

In some embodiments, L>Nc, and at least two second sequence elements in the L second sequence elements are modulated based on channel information of a j^{th} first sequence element in the N_{c} first sequence elements. The second node acquires the channel information of the j^{th} first sequence element upon performing data processing on the at least two third sequence elements corresponding to the at least two second sequence elements. Illustratively, the second node knows that a third second sequence element and a fourth second sequence element in the L second sequence elements are modulated based on channel information of a second first sequence element in the N_{c} first sequence elements, divides or conjugately multiplies a third sequence element and a fourth third sequence element in the L third sequence elements in the received second signal by the third second sequence element and the fourth second sequence element in the L second sequence elements in the configuration information, and takes an average, a maximum, a minimum, or a middle value to acquire the channel information of the second first sequence element.

In some embodiments, L>Nc, and K second sequence elements in the L second sequence elements are modulated based on channel information of the N_{c} first sequence elements. The second node acquires the channel information of the N_{c} first sequence elements upon performing data processing on N_{c} third sequence elements corresponding to the K second sequence elements. Illustratively, the second node knows that the K second sequence elements in the L second sequence elements are modulated based on channel information of the N_{c} first sequence elements, and divides or conjugately multiplies K third sequence elements in the L third sequence elements in the received second signal by the K second sequence elements in the L second sequence elements in the configuration information to acquire the channel information of the N_{c} first sequence elements.

### L<N_{c}

In some embodiments, L<Nc, and the L second sequence elements are modulated based on the channel information of M first sequence elements in the N_{c} first sequence elements. M is a positive integer less than or equal to L. The second node acquires the channel information of the M first sequence elements upon performing data processing on the L third sequence elements. Illustratively, the second node knows that the L second sequence elements are modulated based on channel information of the M first sequence elements in the N_{c} first sequence elements, and divides or conjugately multiplies the L third sequence elements in the received second signal by the L second sequence elements in the configuration information to acquire the channel information of the M first sequence elements.

In summary, in the method according to the embodiments of the present disclosure, channel information in two channel directions is acquired by calculating the set of received signals, such that the resource overhead in the channel feedback process is reduced, and the communication efficiency is improved.

Illustratively, following wireless communication methods are possible in conjunction with the communication scenarios shown in FIG. 2 and FIG. 5. It is understandable that the following wireless communication methods are intended to illustrated, and do not limit the wireless communication methods according to the present disclosure. The feedback mode of the first channel is not applicable to wireless communication scenarios, and applicable to other communication scenarios.

As shown in FIG. 2, the first node 10 transmits a set of signals, and the set of signals includes at least one first signal and at least one second signal. The second signal is transmitted upon modulation based on the channel information of the first channel, and the first signal is not modulated based on the channel information of the first channel. In the case that the second node 20 receives the set of signals, the first signal carries the channel information of the second channel, and the second signal carries the channel information of the first channel and the channel information of the second channel. That is, the second node 20 determines the channel information of the second channel based on the first signal, and determines the channel information of the first channel based on the first signal and the second signal. Illustratively, the first node is a mobile phone, the second node is a vehicle, and the vehicle senses change of the obstacle between the vehicle and the mobile phone based on change (such as a change of amplitude and/or phase) of channel information of the first channel and/or the second channel, and senses a moving speed of the mobile phone based on a Doppler shift of the first channel.

As shown in FIG. 3, the first node 10 transmits a set of signals, and the set of signals includes at least one first signal and at least one second signal. The second signal is transmitted upon modulation based on the channel information of the first channel, and the first signal is not modulated based on the channel information of the first channel. The second node 20 determines the channel information of the first signal and/or the channel information of the second channel based on the set of signals. Illustratively, the first node is a mobile phone, the second node is a vehicle, and the vehicle senses a distance between the vehicle and the mobile phone based on a multipath delay of the second signal, and senses a moving speed and a distance of the mobile phone relative to the base station based on a Doppler shift and a multipath delay of the first channel.

As shown in FIG. 4, the first node 10 acquires the channel information of the first channel (the method is not limited, from the third node 30 to the first node 10), the first node 10 transmits a set of signals, and the set of signals includes at least one first signal and at least one second signal. The first signal is not modulated based on the channel information of the first channel, and the second signal transmitted upon modulation based on the channel information of the first channel and. The second node 20 determines the channel information of the first channel and/or the channel information of the second channel based on the set of signals. Illustratively, in the case that the first node is a mobile phone, the second node is a vehicle, the third node is a base station, and the vehicle is beyond a communication range of the base station, the vehicle senses a distance between the vehicle and the mobile phone based on a multipath delay of the second signal, senses change of the obstacle between the vehicle and the mobile phone based on change (such as a change of amplitude and/or phase) of channel information of the first channel, and senses a distance of the mobile phone and the base station based on a Doppler shift of the first channel.

As shown in FIG. 5, the first node 10 acquires the channel information of the first channel (the method is not limited, from the third node 30 to the first node 10), the first node 10 transmits a set of signals, and the set of signals includes at least one first signal and at least one second signal. The second signal is transmitted upon modulation based on the channel information of the first channel, and the first signal is not modulated based on the channel information of the first channel. The second node 20 determines the channel information of the first channel and/or the channel information of the second channel based on the set of signals. Illustratively, in the case that the first node is a mobile phone, the second node is a vehicle, the third node is a base station, the fourth node is an indoor router, and the vehicle is beyond a communication range of the base station, the vehicle senses a distance between the vehicle and the mobile phone based on a multipath delay of the second signal, and senses change of the obstacle between the indoor router and the base station based on change (such as a change of amplitude and/or phase) of channel information of the first channel.

FIG. 11 is a schematic diagram of a wireless communication scenario according to some embodiments of the present disclosure. the embodiments are illustrated by an example of at least a first node 111 and a second node 113.

In the embodiments, the second channel is a channel from the first node 111 to the second nod 113, and the first channel is a channel from the second channel 113 to the first channel 111, or a channel from another node to the first channel 111. The another node is a router, a power supply device, a peer device, a network device, and the like.

The first node 111 transmits a set of signals based on configuration information, and the configuration information is for configuring a resource of the set of signals. In some embodiments, the configuration information is autonomously determined by the first node 111, configured by the second channel 113 for the first channel 111, or configured by another node for the first channel 111.

In the configuration information, configuration of the first signal and configuration of the second signal are identical, or, the first signal and the second signal are signals independently configured.

The first node 111 transmits a set of signals to the second node 113 based on the configuration information. The set of signals includes at least one first signal and at least one second signal. The first signal is transmitted based on the configuration information, and the second signal is transmitted based on the configuration information upon modulation based on the channel information of the first channel. In some embodiments, the second signal is modulated based on an amplitude and/or a phase of the first channel. Thus, the first signal carries the channel information of the second channel, and the second signal carries the channel information of the first channel and the channel information of the second channel.

The second node 113 receives a set of signals from the first node 111. The channel information of the second channel is acquired by dividing the received first signal by the first signal configured in the configuration information. The channel information of the first channel is acquired by dividing the received second signal by the received first signal.

In summary, in the method according to the embodiments of the present disclosure, the channel information of the second channel is carried in the first signal, and the channel information of the first channel and the channel information of the second channel are simultaneously carried in the second signal by modulating the signal based on the channel, such that lossless channel information feedback mode reduces resource overhead on the premise of meeting feedback requirements of the channel information, and a receiver node acquires channel information in two channel directions. In addition, the feedback flexibility of the channel feedback is improved as the two signals are repetitive signals or independently configured signals.

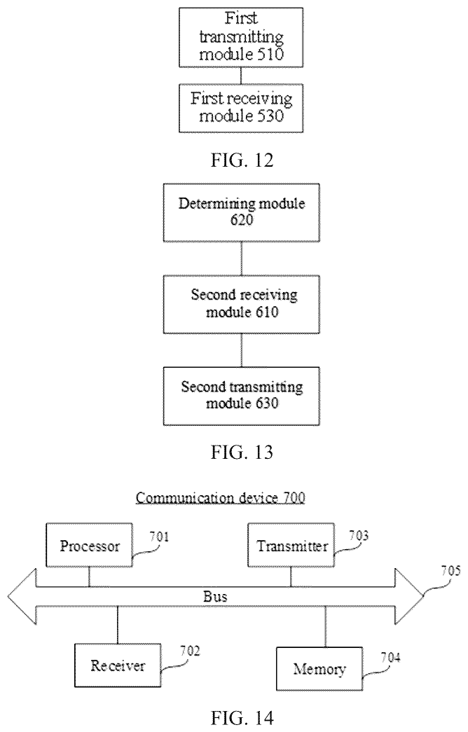

FIG. 12 is a block diagram of an apparatus for wireless communication according to some embodiments of the present disclosure. The apparatus includes at least part of a first transmitting module 510 and a first receiving module 530.

The first transmitting module 510 is configured to transmit a set of signals, the set of signals including at least one first signal and at least one second signal, wherein the at least one first signal is transmitted based on configuration information, and the at least one second signal is transmitted upon modulation based on channel information of a first channel.

In some embodiments, the first channel includes a channel from a second node to the first node.

In some embodiments, the channel information of the first channel includes at least one of an amplitude, a phase, a Doppler shift, or a multipath delay.

In some embodiments, in a case that a sequence of the first channel includes N_{c} first sequence elements, and a sequence of the at least one second signal includes L second sequence elements, the at least one second signal is transmitted upon modulation of the L second sequence elements based on channel information corresponding to all or part of the Nc first sequence elements, wherein L is a sequence length of the at least one second signal in the configuration information, and Nc is a number of frequency domain units corresponding to the first channel.

In some embodiments, in a case that L is equal to N_{c}, an i^{th} second sequence element in the L second sequence elements is transmitted upon modulation based on channel information corresponding to an i^{th} first sequence element in the N_{c} first sequence elements, wherein i is an integer less than or equal to L or N_{c}; in a case that L is greater than N_{c}, at least two second sequence elements in the L second sequence elements are transmitted upon modulation based on channel information corresponding to a j^{th} first sequence element in the N_{c} first sequence elements, wherein j is an integer less than or equal to N_{c}, or, K second sequence elements in the L second sequence elements are transmitted upon modulation based on channel information corresponding to the N_{c} first sequence elements, wherein K is a positive integer less than or equal to N_{c}; or in a case that L is less than N_{c}, the L second sequence elements are transmitted upon modulation based on channel information corresponding to M first sequence elements in the N_{c} first sequence elements, wherein M is a positive integer less than or equal to L.

In some embodiments, the apparatus further includes the first receiving module 530, configured to receive the configuration information, wherein the configuration information is for configuring a resource of the set of signals.

In some embodiments, the configuration information includes at least one of: configuration of the at least one first signal, or configuration of the at least one second signal, wherein the configuration includes at least one of: sequence information, port information, a time domain resource, a frequency domain resource, a code domain resource, power information, or spatial information.

In some embodiments, the configuration information indicates at least one of: sequence information of the at least one first signal is the same as sequence information of the at least one second signal; sequence information of the at least one first signal is different from sequence information of the at least one second signal; port information of the at least one first signal is the same as port information of the at least one second signal; port information of the at least one first signal is different from port information of the at least one second signal; a frequency domain resource of the at least one first signal is the same as a frequency domain resource of the at least one second signal; spatial information of the at least one first signal is the same as spatial information of the at least one second signal; power information of the at least one first signal is the same as power information of the at least one second signal; an interval between a time domain resource of the at least one first signal and a time domain resource of the at least one second signal is less than a first threshold; or a time domain resource of the at least one first signal is the same as a time domain resource of the at least one second signal, and a code domain resource of the at least one first signal is different from a code domain resource of the at least one second signal.

In some embodiments, the configuration information includes configuration of a set of repetitive signals, and configuration of the at least one first signal and configuration of the at least one second signal are determined based on the configuration of the set of repetitive signals.

In summary, the apparatus according to the embodiments of the present disclosure supports to carry the channel information of the second channel in the first signal, and simultaneously carry the channel information of the first channel and the channel information of the second channel in the second signal by modulating the signal based on the channel, such that lossless channel information feedback mode reduces resource overhead on the premise of meeting feedback requirements of the channel information, and a receiver node acquires channel information in two channel directions. In addition, the feedback flexibility of the channel feedback is improved as the two signals are repetitive signals or independently configured signals.

FIG. 13 is a block diagram of an apparatus for wireless communication according to some embodiments of the present disclosure. The apparatus includes at least part of a second receiving module 610 and a second transmitting module 630.

The second receiving module 610 is configured to receive a set of signals from a first node, the set of signals including at least one first signal and at least one second signal, wherein the at least one first signal is transmitted by the first node based on configuration information, and the at least one second signal is transmitted by the first node upon modulation based on channel information of a first channel.

In some embodiments, the first channel includes a channel from the second node to the first node.

In some embodiments, the channel information of the first channel is determined based on the at least one second signal and the at least one first signal.

In some embodiments, the apparatus further includes a determining module 620, configured to determine the channel information of the first channel based on the at least one second signal, the at least one first signal, and a first operation mode.

In some embodiments, the first operation mode includes at least one of: dividing the at least one second signal by the at least one first signal, or conjugately multiplying the at least one second signal by the at least one first signal.j

In some embodiments, the channel information of the first channel is determined based on a quotient of the second signal and the first signal, or, the channel information of the first channel is determined by multiplying the second signal by the conjugate of the second signal.

In some embodiments, the channel information of the first channel includes at least one of an amplitude, a phase, a Doppler shift, or a multipath delay.

In some embodiments, in a case that a sequence of the first channel includes N_{c} first sequence elements, and a sequence of the at least one received second signal includes L second sequence elements, the at least one received second signal is transmitted upon modulation of the L second sequence elements based on channel information corresponding to all or part of the N_{c} first sequence elements, wherein L is a sequence length of the at least one second signal, and N_{c} is a number of frequency domain units corresponding to the first channel.

In some embodiments, in a case that L is equal to Nc, an i^{th} second sequence element in the L second sequence elements is modulated based on channel information corresponding to an i^{th} first sequence element in the Nc first sequence elements, wherein i is an integer less than or equal to L or Nc; in a case that L is greater than Nc, at least two second sequence elements in the L second sequence elements are modulated based on channel information corresponding to a j^{th} first sequence element in the Nc first sequence elements, or, K second sequence elements in the L second sequence elements are modulated based on channel information corresponding to the N_{c} first sequence elements, wherein K is a positive integer less than or equal to Nc; or in a case that L is less than Nc, the L second sequence elements are modulated based on channel information corresponding to M first sequence elements in the Nc first sequence elements, wherein M is a positive integer less than or equal to L.

In some embodiments, the determining module 620 is further configured to determine channel information of a second channel based on the at least one first signal, wherein the second channel is a channel from the first node to the second node.

In some embodiments, the second operation mode includes at least one of: dividing the at least one first signal by the base sequence of the at least one first signal, or conjugately multiplying the at least one first signal by the base sequence of the at least one first signal.

In some embodiments, the determining module 620 is further configured to: determine channel information of the second channel by dividing the received first signal by the first signal configured in the configuration information; or, determine channel information of the second channel by conjugately multiplying the received first signal by the first signal configured in the configuration information.

In some embodiments, the apparatus further includes the second transmitting module 630, configured to transmit the configuration information to the first node, wherein the configuration information is for configuring a resource of the set of signals.

In some embodiments, the configuration information includes at least one of: configuration of the at least one first signal, or configuration of the at least one second signal, wherein the configuration includes at least one of: sequence information, port information, a time domain resource, a frequency domain resource, a code domain resource, power information, or spatial information.

In some embodiments, the configuration information indicates at least one of: sequence information of the at least one first signal is the same as sequence information of the at least one second signal; sequence information of the at least one first signal is different from sequence information of the at least one second signal; port information of the at least one first signal is the same as port information of the at least one second signal; port information of the at least one first signal is different from port information of the at least one second signal; a frequency domain resource of the at least one first signal is the same as a frequency domain resource of the at least one second signal; spatial information of the at least one first signal is the same as spatial information of the at least one second signal; power information of the at least one first signal is the same as power information of the at least one second signal; an interval between a time domain resource of the at least one first signal and a time domain resource of the at least one second signal is less than a first threshold; or a time domain resource of the at least one first signal is the same as a time domain resource of the at least one second signal, and a code domain resource of the at least one first signal is different from a code domain resource of the at least one second signal.

In some embodiments, the configuration information includes configuration of a set of repetitive signals, and configuration of the at least one first signal and configuration of the at least one second signal are determined based on the configuration of the set of repetitive signals.

In summary, the apparatus according to the embodiments of the present disclosure acquires channel information in two channel directions by calculating the set of received signals, such that the resource overhead in the channel feedback process is reduced, and the communication efficiency is improved.

It should be noted that the apparatus according to the above embodiments is only illustrated by the division of the above functional modules. In practical applications, the above functions can be assigned by different functional modules according to needs. That is, the internal structure of the apparatus is divided into different functional modules to achieve all or part of the functions described above.

Detailed operation methods of various modules of the apparatus according to the embodiments are detailed in the method embodiments, and thus are not detailed herein.

FIG. 14 is a schematic structural diagram of a communication device according to some embodiments of the present disclosure. The communication device 700 includes: a processor 701, a receiver 702, a transmitter 703, a memory 704, and a bus 705.

The communication device according to the embodiments includes at least one of a terminal, a network device, a sensing node, a sensing device, a sensing receiver, or a sensing transmitter.

The processor 701, the receiver 702, the transmitter 703, and the memory 704 are connected to each other over the bus 705.

The processor 701 includes one or more processing cores, and achieves various functional applications and information processing by running software programs and modules. In some embodiments, the processor 701 is configured to achieve functions and processes of the above determining module 620.

The receiver 702 and the transmitter 703 are practiced as a communication assembly. The communication assembly is a communication chip. In some embodiments, the receiver 702 is configured to achieve functions and processes of the above first receiving module 530 and/or the second receiving module 610. In some embodiments, the transmitter 703 is configured to achieve functions and processes of the above first transmitting module 510 and/or the second transmitting module 630.

The memory 704 is connected to the processor 701 over the bus 705. The memory 704 is configured to store one or more instructions, and the processor 701, when loading and executing the one or more instructions, is caused to perform various processes in the above method embodiments.

In addition, the memory 704 is practiced by any type of volatile or non-volatile storage device or combinations thereof. The volatile or non-volatile storage device includes but is not limited to a disk or optical disc, an electrically erasable programmable read-only memory (EEPROM), an erasable programmable read-only memory (EPROM), a static random-access memory (SRAM), a read-only memory (ROM), a magnetic memory, a flash memory, or a programmable read-only memory (PROM).

In some embodiments, the receiver 702 receives signals/data separately, the processor 701 controls the receiver 702 to receive signals/data, the processor 701 requests the receiver 702 to receive signals/data, or, the processor 701 cooperates with the receiver 702 to receive signals or data.

In some embodiments, the transmitter 703 transmits signals/data separately, the processor 701 controls the transmitter 703 to transmit signals or data, the processor 701 requests the transmitter 703 to transmit signals/data, or, the processor 701 cooperates with the transmitter 703 to transmit signals or data.

Some embodiments of the present disclosure further provide a computer-readable storage medium storing one or more programs, wherein the one or more programs, when loaded and run by a processor, cause the processor to perform the method for wireless communication in the above method embodiments.

Some embodiments of the present disclosure further provide a chip. The chip includes programmable logic circuitry and/or program instructions, wherein the chip, when running on a communication device, is caused to perform the method for wireless communication in the above method embodiments.

Some embodiments of the present disclosure further provide a computer program product. The computer program product, when running on a processor in a computer device, cause the computer device to perform the method for wireless communication in the above method embodiments.

It should be understood by those skilled in the art that in the above one or more embodiments, functions described in the embodiments of the present disclosure are practiced by the hardware, the software, the firmware or any combinations thereof. In the case that the functions are practiced by the software, the functions are stored in the computer-readable storage medium or are determined as one or more instructions or codes in the computer-readable storage medium for transmission. The computer-readable storage medium includes a computer storage medium and a communication medium, and the communication medium includes any medium facilitating transmission of the computer program from one place to another place. The storage medium is any available medium accessible by a general or specific computer.

Described above are merely exemplary embodiments of the present disclosure, and are not intended to limit the present disclosure. Any modifications, equivalent replacements, improvements and the like made within the spirit and principles of the present disclosure should be encompassed within the scope of protection of the present disclosure.

1. A method for wireless communication, applicable to a first node, the method comprising:
transmitting a set of signals, the set of signals comprising at least one first signal and at least one second signal, wherein the at least one first signal is transmitted based on configuration information, and the at least one second signal is transmitted upon modulation based on channel information of a first channel.

2. The method according to claim 1, wherein the first channel comprises a channel from a second node to the first node.

3. The method according to claim 1, wherein the channel information of the first channel comprises at least one of an amplitude, a phase, a Doppler shift, or a multipath delay.

4. The method according to claim 1, wherein in a case that a sequence of the first channel comprises N_{c} first sequence elements, and a sequence of the at least one second signal comprises L second sequence elements, the at least one second signal is transmitted upon modulation of the L second sequence elements based on channel information corresponding to all or part of the N_{c} first sequence elements, wherein L is a sequence length of the at least one second signal in the configuration information, and N_{c} is a number of frequency domain units corresponding to the first channel.

5. The method according to claim 4, wherein:
in a case that L is equal to N_{c}, an i^{th} second sequence element in the L second sequence elements is transmitted upon modulation based on channel information corresponding to an i^{th} first sequence element in the N_{c} first sequence elements, wherein i is an integer less than or equal to L or N_{c};
in a case that L is greater than N_{c}, at least two second sequence elements in the L second sequence elements are transmitted upon modulation based on channel information corresponding to a j^{th} first sequence element in the N_{c} first sequence elements, wherein j is an integer less than or equal to N_{c}, or, K second sequence elements in the L second sequence elements are transmitted upon modulation based on channel information corresponding to the N_{c} first sequence elements, wherein K is a positive integer less than or equal to N_{c}; or
in a case that L is less than N_{c}, the L second sequence elements are transmitted upon modulation based on channel information corresponding to M first sequence elements in the N_{c} first sequence elements, wherein M is a positive integer less than or equal to L.

6. The method according to claim 1, further comprising:
receiving the configuration information, wherein the configuration information is for configuring a resource of the set of signals.

7. The method according to claim 1, wherein the configuration information comprises at least one of configuration of the at least one first signal or configuration of the at least one second signal, wherein the configuration comprises at least one of sequence information, port information, a time domain resource, a frequency domain resource, a code domain resource, power information, or spatial information.

8. The method according to claim 1, wherein the configuration information indicates at least one of:
sequence information of the at least one first signal is the same as sequence information of the at least one second signal;
sequence information of the at least one first signal is different from sequence information of the at least one second signal;
port information of the at least one first signal is the same as port information of the at least one second signal;
port information of the at least one first signal is different from port information of the at least one second signal;
a frequency domain resource of the at least one first signal is the same as a frequency domain resource of the at least one second signal;
spatial information of the at least one first signal is the same as spatial information of the at least one second signal;
power information of the at least one first signal is the same as power information of the at least one second signal;
an interval between a time domain resource of the at least one first signal and a time domain resource of the at least one second signal is less than a first threshold; or
a time domain resource of the at least one first signal is the same as a time domain resource of the at least one second signal, and a code domain resource of the at least one first signal is different from a code domain resource of the at least one second signal.

9. The method according to claim 1, wherein the configuration information comprises configuration of a set of repetitive signals, and configuration of the at least one first signal and configuration of the at least one second signal are determined based on the configuration of the set of repetitive signals.

10. A communication device, comprising:
a processor, a transceiver connected to the processor, and a memory storing one or more executable programs, which when executed by the processor, causes the communication device to:
transmit a set of signals, the set of signals comprising at least one first signal and at least one second signal, wherein the at least one first signal is transmitted based on configuration information, and the at least one second signal is transmitted upon modulation based on channel information of a first channel.

11. The communication device according to claim 10, wherein the first channel comprises a channel from a second node to the first node.

12. The communication device according to claim 10, wherein the channel information of the first channel comprises at least one of an amplitude, a phase, a Doppler shift, or a multipath delay.

13. A communication device, comprising:
a processor, a transceiver communicably connected to the processor, and a memory storing one or more executable programs, which when executed by the processor, cause the communication device to:
receive a set of signals from a first node, the set of signals comprising at least one first signal and at least one second signal, wherein the at least one first signal is transmitted by the first node based on configuration information, and the at least one second signal is transmitted by the first node upon modulation based on channel information of a first channel.

14. The communication device according to claim 13, wherein the first channel comprises a channel from the second node to the first node.

15. The communication device according to claim 13, wherein the one or more executable programs, which when executed by the processor, further cause the communication device to:
determine the channel information of the first channel based on the at least one second signal and the at least one first signal.

16. The communication device according to claim 15, wherein the channel information of the first channel comprises at least one of an amplitude, a phase, a Doppler shift, or a multipath delay.

17. The communication device according to claim 13, wherein the one or more executable programs, which when executed by the processor, further cause the communication device to:
transmit the configuration information to the first node, wherein the configuration information is for configuring a resource of the set of signals.

18. The communication device according to claim 13, wherein the configuration information comprises at least one of configuration of the at least one first signal, or configuration of the at least one second signal, wherein the configuration comprises at least one of sequence information, port information, a time domain resource, a frequency domain resource, a code domain resource, power information, or spatial information.

19. The communication device according to claim 13, wherein the configuration information indicates at least one of:
sequence information of the at least one first signal is the same as sequence information of the at least one second signal;
sequence information of the at least one first signal is different from sequence information of the at least one second signal;
port information of the at least one first signal is the same as port information of the at least one second signal;
port information of the at least one first signal is different from port information of the at least one second signal;
a frequency domain resource of the at least one first signal is the same as a frequency domain resource of the at least one second signal;
spatial information of the at least one first signal is the same as spatial information of the at least one second signal;
power information of the at least one first signal is the same as power information of the at least one second signal;
an interval between a time domain resource of the at least one first signal and a time domain resource of the at least one second signal is less than a first threshold; or
a time domain resource of the at least one first signal is the same as a time domain resource of the at least one second signal, and a code domain resource of the at least one first signal is different from a code domain resource of the at least one second signal.

20. The communication device according to claim 13, wherein the configuration information comprises configuration of a set of repetitive signals, and configuration of the at least one first signal and configuration of the at least one second signal are determined based on the configuration of the set of repetitive signals.
